(19) United States
(12) Patent Application Publication
(10) Pub. No.: US 2019/0120403 A1
(43) Pub. Date: Apr. 25, 2019

(54) MECHANICAL PRESS-TYPE SWITCH VALVE CORE

(71) Applicant: Guangzhou Seagull Kitchen and Bath Products Co., Ltd., Guangdong (CN)

(72) Inventors: Shuqi Gao, Guangdong (CN); Qianfeng Peng, Guangdong (CN); Rongbao Wei, Guangdong (CN); Tao Luo, Guangdong (CN)

(73) Assignee: Guangzhou Seagull Kitchen and Bath Products Co.,Lt d., Guangdong (CN)

(21) Appl. No.: 15/838,388

(22) Filed: Dec. 12, 2017

(30) Foreign Application Priority Data
Oct. 20, 2017 (CN) 201710982224.0
Oct. 20, 2017 (CN) 201721354604.1

(51) Int. Cl. F16K 31/145; F16K 31/365; F16K 31/40; B01D 39/12

(52) U.S. Cl. CPC F16K 31/145; B01D 39/12; F16K 31/402; F16K 31/365

(57) ABSTRACT

The disclosure provides a mechanical press-type switch valve core, which subverts usage of traditional switch valve core in control of water, switches from rotary switch to press-type switch, and reduces damage of switch handle during use. You can use other parts of body to press the switch (such as arms) when hands are inconvenient in use process. The appearance is relatively simple and generous in the use of the product. The mechanical press-type switch valve core is provided a compression spring between the pressing assembly and the blocking assembly for up-and-down movement acting on the water-blocked rod, and at the same time overcoming water pressure force of the water-blocked rod and O-shape sealing ring when the valve core is opened. The mechanical press-type switch valve core is sealed with the O-shape sealing ring, which is a static seal, and has high sealing life.

### CROSS-REFERENCE TO RELATED APPLICATION

This application claims the priority benefits of China application serial no. 201710982224.0, filed on Oct. 20, 2017, and China application serial no. 201721354604.1, filed on Oct. 20, 2017. The entirety of each of the above-mentioned patent applications is hereby incorporated by reference herein and made a part of specification.

### TECHNICAL FIELD

The present invention belongs to the field of switch valve core, in particular to a mechanical press-type switch valve core.

### BACKGROUND

Pilot valve principle is widely used for solenoid valves and pressure reducing valve, pressure relief valves, other relevant valves. The application is more common for solenoid valves, which use the combination of the electromagnetic principle and pilot valve principle to form solenoid valves. Solenoid valves need to be charged to make pilot valve diaphragms work under a certain working pressure. Another defect is that solenoid valves are not simple enough in structural design, and replacement is relatively more trouble.

### DESCRIPTION

The present invention provides a mechanical press-type switch valve core, which is mainly used for sanitary products, and uses the mechanical press mode to make a pilot valve diaphragm perform switch control of a water inlet front end during the switching process.

The present invention uses the pilot valve principle to make the flow of water form a switch between different cavities under a certain pressure through opening and closing of a pilot hole.

In view of problems mentioned above, the present invention provides a mechanical press-type switch valve core, comprising: a lower seat of valve body, having a first chamber communicating with a water inlet, and a second chamber communicating with a water outlet and communicating with the first chamber through a water outlet channel; an upper seat of valve body, which is sealed in the lower seat of valve body; a pressing and blocking assembly comprising a pressing assembly provided in the upper seat of valve body and having a head end projecting to the upper end of the upper seat of valve body, and a blocking assembly moving up or down in the upper seat of valve body when the pressing assembly is pressed, wherein the end of the blocking assembly has a blocking block; a sealing pilot assembly disposed on the lower seat of valve body, the sealing pilot assembly and the pressing assembly defining a third chamber located above the second chamber, the sealing pilot assembly further having a bypass hole communicating the first chamber and the third chamber, and a pilot hole communicating the second chamber and the third chamber; wherein the pilot hole is blocked when the blocking block is moved downwardly, thereby increasing the amount of water and water pressure of the third chamber so that the sealing pilot assembly moves downwardly to cut off the water outlet channel; the pilot hole being opened when the blocking block is lifted upwards, thereby reducing the amount of water and water pressure of the third chamber so that the sealing pilot assembly floats upward and opens the water outlet channel; a compression spring provided between the pressing assembly and the blocking assembly; an O-shape sealing ring provided between the blocking assembly and the sealing pilot assembly.

Preferably, the mechanical press-type switch valve core, the sealing pilot assembly contains: a support seat; a sealing pilot diaphragm pad disposed below the support seat and sealed and connected with the lower seat of valve body, wherein the sealing pilot diaphragm pad and the support seat together define a activity space of a sealing pilot diaphragm; the sealing pilot diaphragm disposed below the support seat and located in the activity space of the sealing pilot diaphragm, the center position of which is protruded from the sealing pilot diaphragm pad and provided with the pilot hole.

Preferably, the mechanical press-type switch valve core, a through hole is provided in the center position of the support seat, and the upper entrance of the through hole is provided with the O-shape sealing ring; the end of the pressing assembly being provided with a water-blocked rod connected to the blocking assembly, and the water-blocked rod penetrating into the through hole.

Preferably, the mechanical press-type switch valve core, the blocking assembly further comprises a limit block fixed to the blocking block, the limit block having a hollow cavity and the upper portion of the hollow cavity having a limit grain; the water-blocked rod extending into the hollow cavity and limiting by the limit grain, and the outside of the water-blocked rod being sheathed with a water-blocked spring movable up and down within the hollow cavity.

Preferably, the mechanical press-type switch valve core, the pressing assembly also comprises: a button; an indexing member disposed below the button, comprising a first indexing member provided with a plurality of guide teeth on the inner wall, and a second indexing member provided below the first indexing member, a guide groove formed between two adjacent guide teeth, and the outer periphery of the second indexing member being provided with a positioning tooth cooperating with the guide tooth; a water-blocked rod sleeve provided with a limit tooth fitted to the guide groove, and the bottom of the water-blocked rod sleeve being provided with a blind hole; a pressing spring disposed between the button and the indexing member; wherein the head end of the water-blocked rod extends into the blind hole so that the water-blocked rod is fixed to the water-blocked rod sleeve; the bottom of the indexing member having a limit ring, the water-blocked rod being clamped with a limit gasket, and the compression spring being provided between the limit gasket and the limit ring.

Preferably, the mechanical press-type switch valve core, a decontamination spring is arranged between the upper seat of valve body and the sealing pilot assembly, and the upper end of the decontamination spring extends downwardly to form a thimble protruding into the bypass hole.

Preferably, the mechanical press-type switch valve core, the lower seat of valve body is a hollow cylinder and surroundings are provided with a plurality of water inlets, each of which is provided with a stainless steel filter mesh.

Preferably, the mechanical press-type switch valve core, the blocking block is made of rubber material.

The invention provides a mechanical press-type switch valve core, which subverts the usage mode of the traditional switch valve core in the control of water, switches from the rotary switch to the press-type switch, and reduces the damage of the switch handle during use. You can use other parts of the body to press the switch (such as the arm) when hands are inconvenient in the course of use. At the same time appearance is relatively simple and generous in the use of the product.

The invention provides a mechanical press-type switch valve core, which is provided a compression spring between the pressing assembly and the blocking assembly for up-and-down movement acting on the water-blocked rod, and at the same time overcoming water pressure force of the water-blocked rod and O-shape sealing ring when the valve core is opened.

The invention provides a mechanical press-type switch valve core, which is sealed with an O-shape sealing ring, is a static seal, and has a high sealing life.

Other advantages, objects, and features of the present invention will be showed in part through following description, and in part will be understood by those skilled in the art from study and practice of the present invention.

### BRIEF DESCRIPTION OF THE DRAWINGS

FIG. 1 is a part exploded structural view of one embodiment of the mechanical press-type switch valve core provided by the present invention.

FIG. 2 is a work diagram of closing moment of one embodiment of the mechanical press-type switch valve core provided by the present invention.

FIG. 3 is a work diagram of closing completion of one embodiment of the mechanical press-type switch valve core provided by the present invention.

FIG. 4 is a work diagram of opening moment of one embodiment of the mechanical press-type switch valve core provided by the present invention.

FIG. 5 is a work diagram of complete opening of one embodiment of the mechanical press-type switch valve core provided by the present invention.

FIG. 6 is a structural view of one embodiment of the mechanical press-type switch valve core provided by the present invention.

### DETAILED DESCRIPTION

The present invention will now be described in further detail with reference to the accompanying drawings in order to enable person skilled in the art to practice with reference to the description.

It is to be understood that the terms of having, comprising and containing as used herein are not intended to be the presence or addition of one or more other elements or combinations thereof.

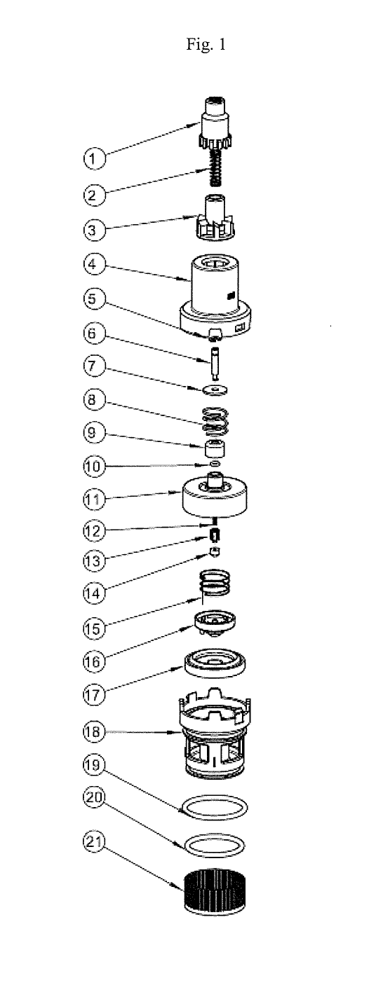

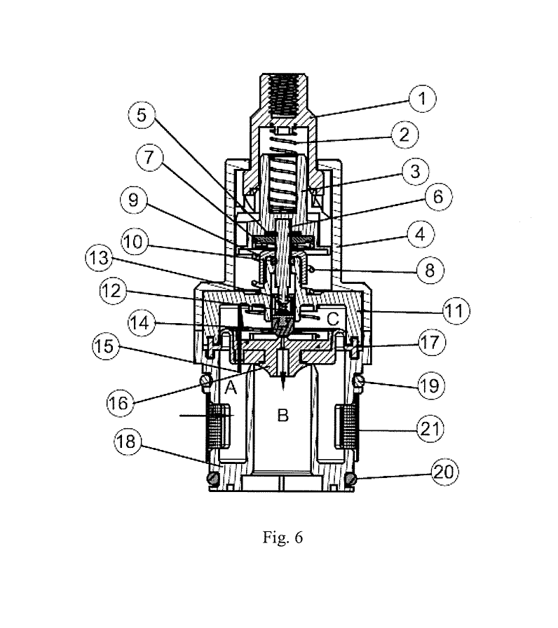

As shown in FIG. 1 and FIG. 6, the present invention provides a mechanical press-type switch valve core, comprising: a lower seat of valve body 18, having a first chamber communicating with a water inlet, a second chamber communicating with a water outlet and communicating with the first chamber through a water outlet channel;
an upper seat of valve body 4, which is sealed in the lower seat of valve body 18; a pressing and blocking assembly comprising a pressing assembly provided in the upper seat of valve body 4 and having a head end projecting to the upper end of the upper seat of valve body 4, and a blocking assembly moving up or down in the upper seat of valve body 4 when the pressing assembly is pressed, wherein the end of the blocking assembly has a blocking block 14; a sealing pilot assembly disposed on the lower seat of valve body 18, the sealing pilot assembly and the pressing assembly defining a third chamber located above the second chamber, the sealing pilot assembly further having a bypass hole communicating the first chamber and the third chamber, and a pilot hole communicating the second chamber and the third chamber; wherein the pilot hole is blocked when the blocking block 14 is moved downwardly, thereby increasing the amount of water and water pressure of the third chamber so that the sealing pilot assembly moves downwardly to cut off the water outlet channel; the pilot hole being opened when the blocking block 14 is lifted upwards, thereby reducing the amount of water and water pressure of the third chamber so that the sealing pilot assembly floats upward to open the water outlet channel; a compression spring 7 provided between the pressing assembly and the blocking assembly; an O-shape sealing ring 10 provided between the blocking assembly and the sealing pilot assembly.

In the mechanical press-type switch valve core, wherein the sealing pilot assembly contains: a support seat 11; a sealing pilot diaphragm pad 17 disposed below the support seat 11 and sealed and connected with the lower seat of valve body 18, wherein the sealing pilot diaphragm pad 17 and the support seat together define an activity space of a sealing pilot diaphragm; the sealing pilot diaphragm 16 disposed below the support seat 11 and located in the activity space of the sealing pilot diaphragm, the center position of which is protruded from the sealing pilot diaphragm pad 17 and provided with the pilot hole.

In the mechanical press-type switch valve core, a through hole is provided in the center position of the support seat 11, and the upper entrance of the through hole is provided with the O-shape sealing ring 10; the end of the pressing assembly being provided with a water-blocked rod 6 connected to the blocking assembly, and the water-blocked rod 6 penetrating into the through hole.

In the mechanical press-type switch valve core, the blocking assembly further comprises a limit block 13 fixed to the blocking block 14, the limit block 13 having a hollow cavity and the upper portion of the hollow cavity having a limit grain; the water-blocked rod 6 extending into the hollow cavity and limiting by the limit grain, and the outside of the water-blocked rod 6 being sheathed with a water-blocked spring 12 movable up and down within the hollow cavity.

In the mechanical press-type switch valve core, the pressing assembly also comprises: a button 1; an indexing member 3 disposed below the button 1, comprising a first indexing member provided with a plurality of guide teeth on the inner wall, and a second indexing member provided below the first indexing member, a guide groove formed between two adjacent guide teeth, and the outer periphery of the second indexing member being provided with a positioning tooth cooperating with the guide tooth; a water-blocked rod sleeve provided with a limit tooth fitted to the guide groove, and the bottom of the water-blocked rod sleeve being provided with a blind hole; a pressing spring 2 disposed between the button 1 and the indexing member 3; wherein the head end of the water-blocked rod 6 extends into the blind hole so that the water-blocked rod 6 is fixed to the water-blocked rod sleeve; the bottom of the indexing member having a limit ring, the water-blocked rod clamped with a limit gasket 5, and the compression spring 7 provided between the limit gasket 5 and the limit ring.

The working principle of the pressing assembly is the same as that of the press-type ballpoint pen, and it is known for common knowledge and is not introduced here.

In the mechanical press-type switch valve core, a decontamination spring 12 is arranged between the upper seat of valve body and the sealing pilot assembly, and the upper end of the decontamination spring 12 extends downwardly to form a thimble protruding into the bypass hole.

In the mechanical press-type switch valve core, the lower seat of valve body 18 is a hollow cylinder and surroundings are provided with a plurality of water inlets, each of which is provided with a stainless steel filter mesh 21.

In the mechanical press-type switch valve core, the blocking block 14 is made of rubber material.

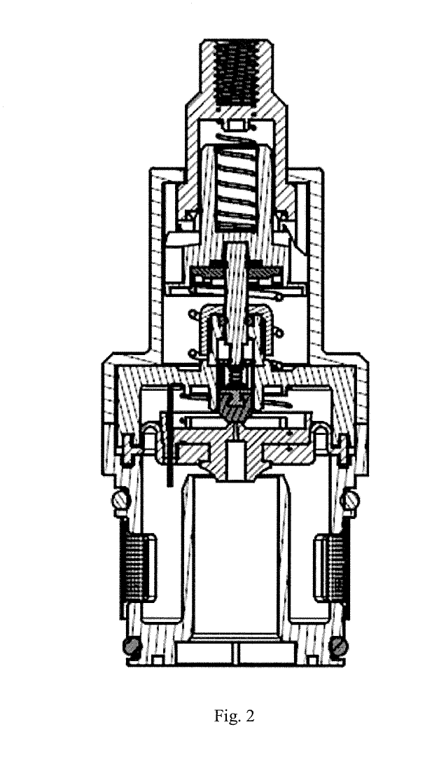

FIGS. 2, 3, 4 and 5 are workflow diagrams of the mechanical press-type switch valve core provided by the present invention.

As shown in FIG. 2, the water flow flows from the water inlet into the first chamber and flows from the first chamber through the water outlet channel and the bypass hole into the second chamber and the third chamber, respectively, and flows from the third chamber through the pilot hole into the second chamber, at this moment the sealing pilot diaphragm being in the floating state, the water outlet channel being communicated.

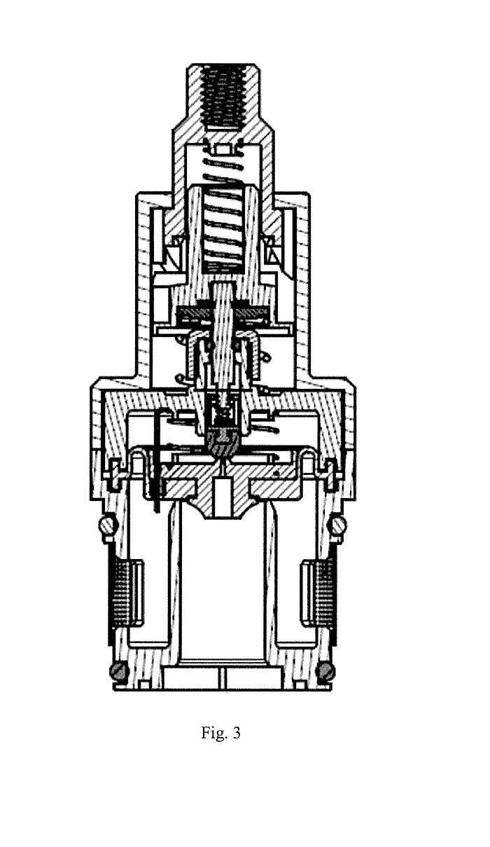

As shown in FIG. 3, after pressing the button, the water-blocked rod drives the blocking block to move downward and then block the pilot hole, where the water in the third chamber no longer flows into the second chamber, thereby increasing the amount of water in the third chamber, the sealing pilot diaphragm moving downward under gravity of the water and closing the water outlet channel.

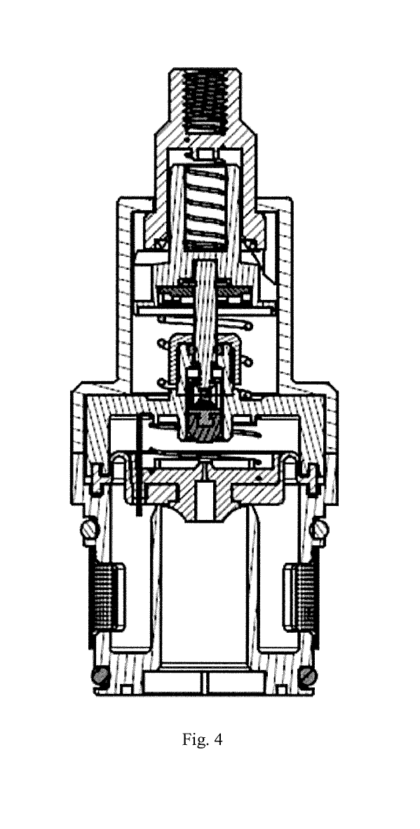

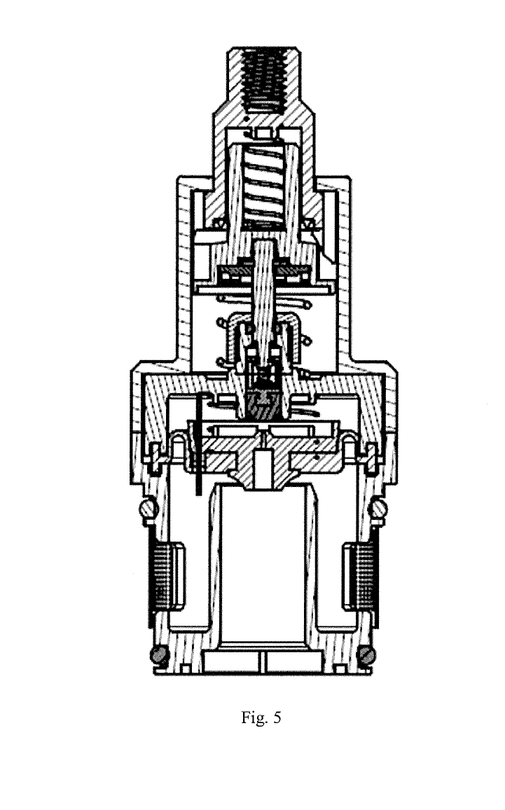

As shown in FIG. 4, after pressing the button again, the water-blocked rod drives the blocking block to move upward and then open the pilot hole, where the water in the third chamber flows into the second chamber, thereby reducing the amount of water in the third chamber to as shown in FIG. 5, the sealing pilot diaphragm floating upward and opening the water outlet channel.

As shown in FIG. 6, the mechanical press-type switch valve core of the present invention, comprises a lower seat of valve body 18 and an upper seat of valve body 4 sealed in the lower seat of valve body 18, the lower seat of valve body 18 having a first chamber A and a second chamber B, and a third chamber C communicating with the first chamber A. The present invention also contains a sealing pilot diaphragm 16 and a button 1, a pressing spring 2. The sealing pilot diaphragm 16 is provided between the support seat 11 and the lower seat of valve body 18 and can close or open the water outlet channel by means of a water pressure difference. The third chamber C is formed between the sealing pilot diaphragm 16 and the support seat 11, and the sealing pilot diaphragm 16 are provided with a bypass holes communicating with the third chamber C and the first chamber A, and have a decontamination spring 15 and a pilot hole located in the middle and communicating with the third chamber C and the second chamber B. The pressing assembly is composed of the button 1, a pressing spring 2 and a switching limit grain 3. Under the action of the deformation spring 8, the water-blocked rod 6 and a pad 7 are driven by the switching displacement and pass through the O-shape sealing ring to move up and down in the support seat 11. The water-blocked rod 6 is blocked on the pilot hole in the sealing pilot diaphragm 16 to produce a pressure difference immediately so that the pressure of the third chamber C is greater than that of the first chamber A, at the same time, the sealing pilot diaphragm 16 is sealed to the lower seat of valve body 18, so as to close the flow of water. In contrast, the water-blocked rod 6 is away from the pilot hole in the sealing pilot diaphragm 16 so that the pressure in the first chamber A zone is greater than that of the third chamber C, thereby opening the water outlet channel and the water flowing from the first chamber A to the second chamber B.

The invention provides a mechanical press-type switch valve core, the upper part of which adopts the pressing and switching structure principle of the mechanical ballpoint pen, and the lower part of which adopts the pilot valve structure principle, the combination of both making press-type switch valve core achieve a mechanical press switch in the case of relatively simple appearance.

The invention provides a mechanical press-type switch valve core. Parts of the product are mainly composed of POM wear-resistant plastic parts, EPDM sealing parts, silicone, and spring SUS304. The requirements of the relevant water passing parts meet the national certification requirements.

The invention provides a mechanical press-type switch valve core, which is ingeniously used of switching the upper and lower positions structure of the ballpoint pen to drive the middle water-blocked rod, so that the water-blocked rod blocks the pilot hole of the sealing pilot diaphragm in the case of transmission, so that water to guide the sealing pilot diaphragm moves up and down under pressure. The transmission mechanism in the manufacturing process is required to ensure that the tolerance of assembly parts is at about 0.1 mm.

The invention provides a mechanical press-type switch valve core, which solves the effective movement of the mechanical water-blocked rod in the transmission overshoot when pressing and switching. By the pressing assembly to drive the blocking block of the bottom of the water-blocked rod, while the water-blocked rod sleeve also increases the stability of the water-blocked rod in the movement. The existing valve core is used of the solenoid structure, so that the upper and lower positions of the water-blocked rod are changed under the up and down movement of the magnet, thereby playing the role of sealing water.

The invention provides a mechanical press-type switch valve core, which comprises the upper seat of valve body and the lower seat of valve body. A support seat is mounted between the upper seat of valve body and the lower seat of valve body. The button, pressing spring and the indexing member are mounted in series on the upper part of the support seat. The water-blocked spring, the limit block, a water-blocked block and sealing pilot diaphragm are mounted in series on the lower part of the support seat. The sealing pilot diaphragm is positioned by sealing pilot diaphragm pad. The lower seat of valve body is a hollow partition cylinder, and the lower periphery of the lower seat of valve body is provided with a plurality of water inlets. A stainless steel filter mesh is covered on the water inlet so that the water is protected by filtration in the front, which is different from the traditional ceramic sealling water valve core in the actual use process.

The invention provides a mechanical press-type switch valve core, which only needs to put one or several mechanical press-type switch valve core into the main body of a faucet product for realization of product function switching, so that front end of water outlet of each valve core controls of a kind of function. The mechanical press-type switch valve core is not only simple operation, simple assembly, but also can save the manufacturing costs of faucets, and is widely used in a variety of sanitary products.

The invention provides a mechanical press-type switch valve core, which is more labor-saving, more concise and convenient than the structure of traditional technology through a control rod directly blocking the water outlet channel because of adopting the principle of pilot structure.

Although the embodiments of the present invention have been disclosed above, they are not limited to the applications previously mentioned in the specification and embodiments, and can be applied in various fields suitable for the present invention. For ordinary skilled person in the field, other various changed model, formula and parameter may be easily achieved without creative work according to instruction of the present invention, changed, modified and replaced embodiments without departing the general concept defined by the claims and their equivalent are still included in the present invention. The present invention is not limited to particular details and illustrations shown and described herein.

1. A mechanical press switch valve core, comprising:
a lower seat body of valve body, comprising:
a first chamber, communicating with a water inlet; and
a second chamber, communicating with a water outlet and communicating with the first chamber through a water outlet channel;
an upper seat body of valve body, installed in the lower seat body of valve body;
a pressing and blocking assembly, comprising:
a pressing assembly, provided in the upper seat body of valve body and having a head end projecting to an upper end of the upper seat body of valve body; and
a blocking assembly, moving up or down in the upper seat body of valve body when the pressing assembly is pressed, wherein an end of the blocking assembly has a blocking block;
a sealing pilot assembly, disposed on the lower seat body of valve body, the sealing pilot assembly and the pressing assembly defining a third chamber located above the second chamber, wherein the sealing pilot assembly comprises:
a bypass hole, communicating with the first chamber and the third chamber; and
a pilot hole, communicating with the second chamber and the third chamber,
wherein the pilot hole is blocked when the blocking block is moved downwardly, thereby increasing the amount of water and water pressure in the third chamber so that the sealing pilot assembly moves downwardly to cut off the water outlet channel,
wherein the pilot hole is opened when the blocking block is lifted upwardly, thereby reducing the amount of water and water pressure in the third chamber so that the sealing pilot assembly floats upward and opens the water outlet channel;
a compression spring, provided between the pressing assembly and the blocking assembly; and
an O-shape sealing ring, provided between the blocking assembly and the sealing pilot assembly.

2. The mechanical press switch valve core according to claim 1, wherein the sealing pilot assembly further comprises:
a support seat; and
a sealing pilot diaphragm pad, disposed below the support seat and sealed and connected with the lower seat body of valve body, wherein the sealing pilot diaphragm pad and the support seat together define an activity space of a sealing pilot diaphragm,
wherein the sealing pilot diaphragm is disposed below the support seat and located in the activity space of the sealing pilot diaphragm, and a center position of the support seat is protruded from the sealing pilot diaphragm pad and provided with the pilot hole.

3. The mechanical press switch valve core according to claim 2, wherein a through hole is provided in the center position of the support seat, and an upper entrance of the through hole is provided with the O-shape sealing ring, wherein an end of the pressing assembly is provided with a water-blocked rod connected to the blocking assembly, and the water-blocked rod penetrating into the through hole.

4. The mechanical press switch valve core according to claim 3, wherein the blocking assembly further comprises a limit block fixed to the blocking block, the limit block having a hollow cavity, and an upper portion of the hollow cavity having a limit bead, wherein the water-blocked rod extends into the hollow cavity and is limited by the limit bead, and an outside of the water-blocked rod being sheathed with a water-blocked spring movable up and down within the hollow cavity.

5. The mechanical press switch valve core according to claim 4, wherein the pressing assembly further comprises:
a button;
an indexing member, disposed below the button, comprising:
a first indexing member, provided with a plurality of guide teeth on an inner wall of the indexing member; and
a second indexing member, provided below the first indexing member, wherein a guide groove is formed between two adjacent guide teeth, and an outer periphery of the second indexing member is provided with a positioning tooth cooperating with the guide tooth;
a water-blocked rod sleeve, provided with a limit tooth fitted to the guide groove, and a bottom of the water-blocked rod sleeve is provided with a blind hole; and
a pressing spring, disposed between the button and the indexing member,
wherein a head end of the water-blocked rod extends into the blind hole so that the water-blocked rod is fixed to the water-blocked rod sleeve, a bottom of the indexing member has a limit ring, the water-blocked rod is clamped with a limit gasket, and the compression spring is provided between the limit gasket and the limit ring.

6. The mechanical press switch valve core according to claim 1, wherein a decontamination spring is arranged between the upper seat body of valve body and the sealing pilot assembly, and an upper end of the decontamination spring extends downwardly to form a thimble protruding into the bypass hole.

7. The mechanical press switch valve core according to claim 1, wherein the lower seat body of valve body is a hollow cylinder, and surroundings of the lower seat body of valve body are provided with a plurality of water inlets, each of which is provided with a stainless steel filter mesh.

8. The mechanical press-type switch valve core according to claim 1, wherein the blocking block is made of rubber material.
